(19) United States
(12) Patent Application Publication
(10) Pub. No.: US 2012/0107089 A1
(43) Pub. Date: May 3, 2012

(54) Fluid Flow Control System Having a Moving Fluid Expander Providing Flow Control and Conversion of Fluid Energy into Other Useful Energy Forms

(75) Inventors: Krishnamurthy Vaidyanathan, Morristown, NJ (US); Syed Shahed, Morristown, NJ (US)

(73) Assignee: HONEYWELL INTERNATIONAL INC., Morristown, NJ (US)

(21) Appl. No.: 13/382,547

(22) PCT Filed: Jun. 29, 2010
(86) PCT No.: PCT/US2010/040342

§ 371 Date: Jan. 6, 2012

Related U.S. Application Data
(60) Provisional application No. 61/223,951, filed on Jul. 8, 2009.

(51) Int. Cl. F04D 27/00; F02B 77/00

(52) U.S. Cl. 415/1; 123/2; 137/338

(57) ABSTRACT

A fluid flow control system for controlling flow of a primary fluid to a downstream flow-inducing device includes a moving fluid expander with variable expansion ratio and variable speed arranged to receive the flow of the primary fluid and to expand the primary fluid, resulting in a reduction in temperature of the primary fluid. The system further includes an optional heat exchanger arranged to receive the reduced-temperature primary fluid as well as a higher-temperature secondary fluid and to cause varying degrees of heat exchange between the primary and secondary fluids such that the secondary fluid is cooled by the primary fluid. The primary fluid is discharged from the heat exchanger and is supplied to the flow-inducing device.

### BACKGROUND OF THE INVENTION

The present disclosure relates generally to fluid flow control. More particularly, the disclosure relates to applications where a throttling device is used to reduce the flow rate of a moving fluid, for the purpose of achieving a certain functionality such as air/fuel ratio control in a spark-ignited internal combustion engine.

Traditionally, control of fluid flow in various types of flow control applications has been accomplished using a throttle. The throttle is essentially an element, of appropriate shape, which is interposed in the flow passage, with the objective of modifying the effective flow area, to meet the flow requirement needed for achieving a functional purpose. As an example, throttles have traditionally been used in automotive applications as flow control devices. Some common applications of throttles include: air flow control in gasoline engines, which also acts to control engine power; exhaust gas recirculation control; air flow control of diesel engines using pneumatic governors; etc. In a conventional throttle, the fluid flow is varied by adjusting the throttle position in such a way that the effective flow area is reduced or increased as required. However, by virtue of its design, the conventional throttle induces a significant pressure drop in the fluid flow and a lot of energy is wasted in inducing fluid flow by overcoming the pressure restriction introduced by the throttle.

Thus, while the throttle achieves the intended objective of flow control, a significant amount of energy is expended by the suction device downstream of the throttle to induce the fluid flow. The energy so expended by the inducing device is inevitably lost as heat, vibration, and noise. This energy loss is especially pronounced when the flow rate of fluid is high, such as air induction at high engine speeds, and this is further exacerbated when the degree of flow reduction needed is high, such as during part-load operation.

### BRIEF SUMMARY OF THE DISCLOSURE

In accordance with the present disclosure, the drawbacks of conventional throttles for reducing fluid flow rate are at least partially overcome by the use of a moving fluid expander having a variable expansion ratio and, preferably, provision for speed control. The moving fluid expander replaces the conventional throttle. The term “moving fluid expander” encompasses any device having an element that is moved by the fluid such that the fluid does work on the element, resulting in expansion of the fluid. Additional flow control can be achieved in the moving fluid expander by controlling the operational speed of the expander. Various configurations of expanders can be used, including but not limited to rotary and reciprocating types of moving fluid expanders. The moving fluid expander performs the function of a flow control device while also converting kinetic, pressure, and/or thermal energy of the fluid flow stream into other energy forms that are usefully available. The system described herein can generally replace any flow-restriction device where there is an opportunity to recover a significant proportion of the energy lost in throttling the flow.

In one embodiment, a fluid flow control system for controlling flow of a primary fluid to a downstream flow-inducing device comprises a moving fluid expander with variable expansion ratio and speed control arranged to receive the flow of the primary fluid and to expand the primary fluid, resulting in the desired flow rate, while achieving a reduction in temperature of the primary fluid. The moving fluid expander is controllable to vary the speed of operation and the expansion ratio imparted to the primary fluid. The system further comprises an optional heat exchanger arranged to receive the reduced-temperature primary fluid as well as a higher-temperature secondary fluid and to cause a desired degree of heat exchange between the primary and secondary fluids such that the secondary fluid is cooled by the primary fluid, the heat exchanger having an outlet through which the primary fluid is discharged for supply to the flow-inducing device.

In some embodiments, the primary purpose of the system may be flow control, and in others the primary purpose may be temperature reduction, and in certain other embodiments a combination of flow control and temperature reduction may be used in differing degrees to achieve an intended function of the system.

The moving fluid expander optionally can drive one or more auxiliary devices, a non-limiting example of which is an electrical generator.

In some embodiments, the moving fluid expander comprises a rotary expander such as a variable expansion ratio turbine, in which the variation in expansion ratio is accomplished by suitably adjusting the flow area, air flow velocity, and angle of fluid incident on the turbine blades. For example, the rotary expander can comprise a variable nozzle turbine (VNT) or a turbine having a slidable piston or sleeve for adjusting the flow area leading into the turbine wheel of the moving fluid expander. The moving fluid expander speed may be adjusted for optimum functionality by suitably loading the output shaft of the expander using the driven (auxiliary) device.

In some embodiments, the moving fluid expander comprises a reciprocating expander such as a swash plate piston system, in which the variation in expansion ratio is accomplished by varying the stroke of the piston. Additional flow control may be accomplished by varying the operating speed of the moving fluid expander. For example, the reciprocating expander can comprise a system to vary the stroke of the piston with the objective of controlling the downstream pressure and hence flow rate.

In other embodiments, the moving fluid expander may employ one or more lobed rotary pistons such as used in Wankel engines to achieve a similar functionality.

The moving fluid expander replaces a conventional throttle by providing the same functionality of flow control. This is achieved by regulating the degree of expansion of the primary fluid in the moving fluid expander (e.g., by adjusting the variable nozzle or piston, in the case of a turbine) and adjusting the operating speed of the moving fluid expander, to achieve the desired pressure and temperature, and hence density, of the fluid discharged from the moving fluid expander, thereby providing the desired mass flow rate of the primary fluid. The expanding primary fluid performs work on the turbine or other moving element of the moving fluid expander and generates mechanical power. Additionally, the expansion of the primary fluid results in a reduction in temperature of the primary fluid.

The fluid flow control system can be used in conjunction with various types of downstream flow-inducing devices. In some embodiments, the flow-inducing device is an internal combustion engine. The primary fluid includes air and is supplied to an air intake of the internal combustion engine.

The internal combustion engine can be part of a vehicle having a passenger compartment. In that case, the heat exchanger can be arranged to receive relatively warm air from the passenger compartment as the secondary fluid and to cool the air and return the air to the passenger compartment.

In other cases, the heat exchanger can be arranged to receive the secondary fluid from a sub-system and to cool the secondary fluid and return the secondary fluid to the sub-system. The heat exchanger and sub-system can form a closed fluid circuit for the secondary fluid.

In some embodiments, the system can further comprise an electrical generator coupled with the moving fluid expander for being driven by the moving fluid expander so as to produce electrical current. The system can also include an electrical energy storage device and a charging device connected therewith, the charging device being arranged to receive the electrical current produced by the electrical generator and to charge the electrical energy storage device.

In a general embodiment, the system can further comprise one or more auxiliary devices coupled with the moving fluid expander for being driven by the moving fluid expander so as to perform an intended function.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is a schematic depiction of a fluid flow control system in accordance with one embodiment of the present invention;

FIG. 2 is a schematic depiction of a fluid flow control system in accordance with another embodiment of the present invention; and

FIG. 3 is a schematic depiction of a fluid flow control system in accordance with a further embodiment of the present invention.

### DETAILED DESCRIPTION OF THE DRAWINGS

The present invention now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

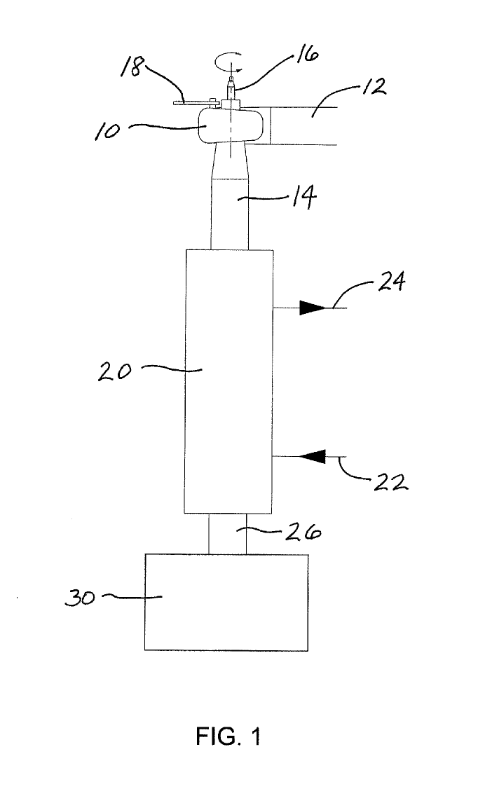

FIG. 1 depicts a fluid flow control system in accordance with one embodiment of the present invention. The system includes a moving fluid expander 10 that receives a flow of a primary fluid through a conduit 12, expands the primary fluid, and discharges the expanded fluid through a conduit 14. The moving fluid expander 10 in the illustrated embodiment comprises a variable expansion ratio turbine having a rotatable shaft 16. The variable expansion ratio turbine includes a variable-geometry mechanism (e.g., a variable turbine nozzle or a sliding piston, not shown) that is adjustable in position via an actuator member 18 that is moved by a suitable actuator device (not shown). The fluid flow control system further includes a heat exchanger 20 that receives the expanded primary fluid from the conduit 14. The heat exchanger is structured to also receive a secondary fluid via an inlet conduit 22 and to cause heat exchange between the primary fluid and the secondary fluid, and to discharge the secondary fluid through an outlet conduit 24. The primary fluid is discharged from the heat exchanger via a conduit 26 for supply to a downstream flow-inducing device 30.

In one embodiment, the heat exchanger 20 may be omitted if it is determined that the application downstream of conduit 14 is functionally benefited by the cooling effect induced by the expander. In another embodiment, a provision may be made to dynamically vary the degree of heat exchanged with the fluid moving through conduit 14, so as to create favorable functionality of the system downstream of conduit 14 and/or in the secondary fluid flow system

The expansion of the primary fluid by the moving fluid expander 10 causes the primary fluid to be reduced in temperature. The extent of temperature reduction is dependent on the pressure drop across the expander; generally, a larger pressure drop across the expander results in a larger temperature drop. The reduced-temperature primary fluid entering the heat exchanger via the conduit 14 is at a lower temperature than the secondary fluid entering the heat exchanger via the inlet conduit 22. Accordingly, the heat exchanger causes the secondary fluid to be cooled by the primary fluid.

The variable-geometry mechanism inside the moving fluid expander 10 is adjusted using the actuator member 18 to achieve the desired flow rate through the expander. This also helps to direct the incoming fluid optimally on the rotating blades for maximum energy extraction, with minimal losses.

The speed of the moving fluid expander 10 can be adjusting by modulating the load imposed by the driven device 40 coupled to the expander to maximize the energy extraction while achieving the intended flow and pressure drop.

The fluid flow control system of FIG. 1 can be used for regulating flow to various types of flow-inducing devices 30.

One particular application of the present invention where significant benefit can be realized is the throttle in internal combustion engines. In a typical internal combustion engine, air is inducted from the atmosphere through an air cleaner and flows through a throttle. Depending on the engine power requirements, the throttle is adjusted using a device such as a butterfly valve to reduce the available area of flow and achieve the desired air flow rate. The air at reduced flow rate is drawn into the engine. A serious limitation of this arrangement is that a significant amount of energy is lost in throttling the air flow in the throttle valve, and this loss of energy is all the more pronounced when the engine is operating at high-speed, low-load conditions where significant throttling is required. This is because the fixed engine displacement cannot normally be changed to vary the air flow depending on load conditions.

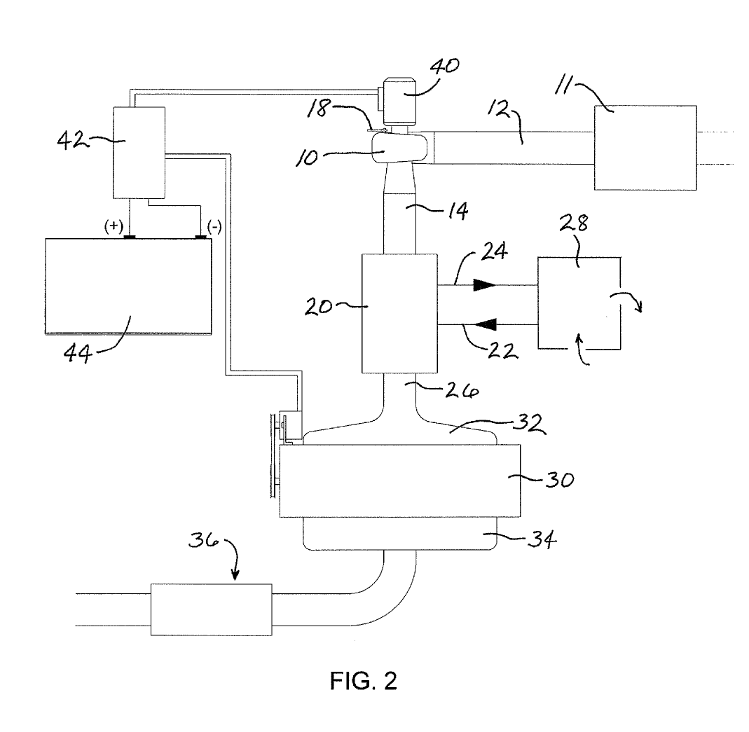

With reference to FIG. 2, a fluid flow control system in accordance with another embodiment of the invention is shown in conjunction with an internal combustion engine 30. The system includes a moving fluid expander 10 that receives a flow of a primary fluid (i.e., air or an air/fuel mixture) through a conduit 12, expands the primary fluid, and discharges the expanded fluid through a conduit 14. The air is first passed through an air cleaner 11 before it is supplied to the moving fluid expander 10. The moving fluid expander 10 in the illustrated embodiment comprises a variable expansion ratio turbine. The variable expansion ratio turbine includes a variable-geometry mechanism (e.g., a variable turbine nozzle or a sliding piston, not shown) that is adjustable in position via an actuator member 18 that is moved by a suitable actuator device (not shown). The fluid flow control system further includes a heat exchanger 20 that receives the expanded primary fluid from the conduit 14. The heat exchanger is structured to also receive a secondary fluid via an inlet conduit 22 and to cause heat exchange between the primary fluid and the secondary fluid, and to discharge the secondary fluid through an outlet conduit 24. The primary fluid is discharged from the heat exchanger via a conduit 26 for supply to an air intake manifold 32 of the engine 30. Exhaust gases from the engine are discharged from the engine's exhaust manifold 34 through an exhaust system 36.

The actuator member 18 of the moving fluid expander is adjusted as needed in order to optimize the air flow introduction to the turbine of the moving fluid expander for optimum extraction of energy. The mechanical energy so extracted is fed from the turbine shaft to an electrical generator 40, which converts mechanical energy from the turbine shaft into electrical current. The speed of the expander is adjusted, if needed, by varying the load imposed by the driven device 40 for maximum extraction of energy. The electrical current produced by the generator 40 is fed to an inverter/rectifier charging and control system 42 to an appropriate electrical storage device 44 which may already exist or may be custom made for application of the present invention.

More generally, instead of (or in addition to) an electrical generator 40, one or more other auxiliary devices may be driven by the moving fluid expander 40. The moving fluid expander may drive each auxiliary device directly by a mechanical connection therebetween, or indirectly such as by pneumatic, hydraulic, electrical, or magnetic means.

The thermodynamic process of expansion across the moving fluid expander 10 removes heat from the incoming air and hence the air exiting from the expander is significantly colder than inlet air. To meet the temperature requirement of the engine 30, the exiting air is led through an optional heat exchanger 20 where it acquires heat to a predetermined degree from any fluid that needs to be cooled. In the illustrated implementation of FIG. 2, warm air from a vehicle passenger compartment 28 is circulated through the heat exchanger 20 and exchanges heat with the air from the moving fluid expander 10. The fluid circuit for the passenger compartment air is generally an open circuit, wherein fresh air is supplied continually to the passenger compartment and some of the air is vented to the ambient surroundings, as shown by the arrows into and out of the passenger compartment 28.

As noted, the heat exchanger 20 may be omitted if it is determined that the application downstream of conduit 14 is functionally benefited by the cooling effect induced by the expander. In another embodiment, a provision may be made to dynamically vary the degree of heat exchanged from the fluid moving through conduit 14, so as to create favorable functionality of the system downstream of conduit 14

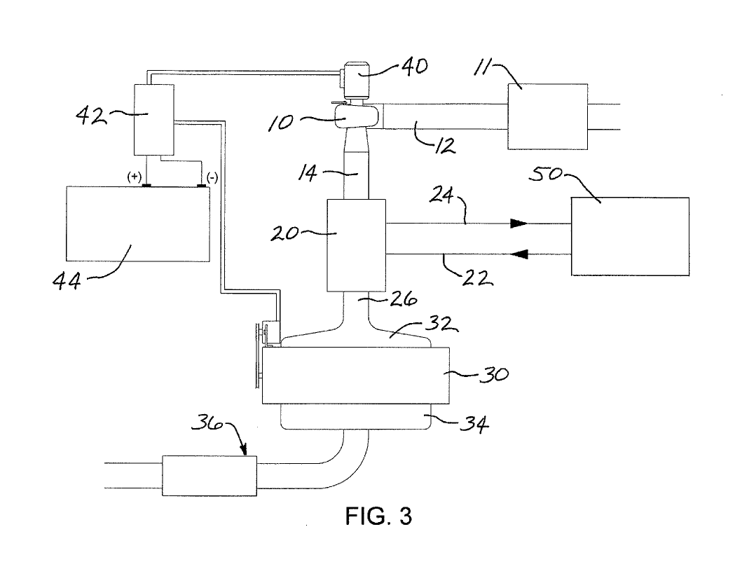

The cooling effect provided by the reduced-temperature primary fluid from the moving fluid expander in accordance with the present invention is not limited to the air conditioning of a passenger compartment, but can be applied to any cooling requirement. For example, as shown in FIG. 3, the system substantially as depicted in FIG. 2 is shown being used in conjunction with a sub-system 50 that utilizes a secondary fluid. The heat exchanger 20, conduits 22 and 24, and sub-system 50 can form a closed fluid circuit for the secondary fluid, if desired. The engine inlet air temperature can be adjusted according to engine requirements, by appropriately regulating the heat exchange between the primary and secondary fluids in the heat exchanger 20.

Embodiments of the present invention provide for recovering mechanical energy and cooling potential from the fluid flow control process. Both of these are dependent on the flow rate through the expander and the degree of expansion across the expander. In certain applications, the cooling effect of the fluid may be variably recovered using an external fluid, or passed on to the flow-inducing system for achieving an intended functional benefit. Hence, large installations such as process plants stand to significantly benefit by the application of both these aspects of this invention.

In the case where the fluid flow control system of the present invention is used with an internal combustion engine, driving cycle measurements show the potential to realize fuel efficiency benefits of approximately 5% on a typical City driving cycle. The energy recovery benefits can be higher when the system is applied in operating conditions where the engine has to frequently operate at high-speed, low-load conditions where significant throttling of intake fluid in combination with a reasonable fluid flow is required.

In accordance with the present invention, the energy generated by the moving fluid expander can be used as soon as it is generated (e.g., to immediately drive another device), or the generated energy can be stored in a suitably converted form for subsequent use. Moreover, the energy generated can be used on a continuous basis or on an intermittent basis.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A fluid flow control system for controlling flow of a primary fluid to a downstream flow-inducing device, comprising:
a moving fluid expander with variable expansion ratio arranged to receive the flow of the primary fluid and to expand the primary fluid, resulting in a reduction in temperature of the primary fluid, the moving fluid expander being controllable to vary the flow rate and expansion ratio imparted to the primary fluid; and
a heat exchanger arranged to receive the reduced-temperature primary fluid as well as a higher-temperature secondary fluid and to cause heat exchange between the primary and secondary fluids such that the secondary fluid is cooled by the primary fluid, the heat exchanger having an outlet through which the primary fluid is discharged for supply to the flow-inducing device.

2. The fluid flow control system of claim 1, wherein the moving fluid expander is controllable as to speed of operation thereof.

3. The fluid flow control system of claim 1, wherein the moving fluid expander is operable to expand the primary fluid to a predetermined pressure and to impart a predetermined flow rate to the primary fluid.

4. The fluid flow control system of claim 1, wherein the heat exchanger is controllable as to a degree of heat exchange between the primary and secondary fluids.

5. The fluid flow control system of claim 1, wherein the moving fluid expander comprises a variable expansion ratio turbine.

6. The fluid flow control system of claim 1, in combination with an internal combustion engine arranged to receive the primary fluid from the outlet of the heat exchanger, wherein the primary fluid includes air and is supplied to an air intake of the internal combustion engine.

7. The fluid flow control system in combination with the internal combustion engine according to claim 6, wherein the internal combustion engine is part of a vehicle having a passenger compartment, and the heat exchanger is arranged to receive relatively warm air from the passenger compartment as the secondary fluid and to cool the air to varying degrees and return the air to the passenger compartment.

8. The fluid flow control system in combination with the internal combustion engine according to claim 6, wherein the heat exchanger is arranged to receive the secondary fluid from a sub-system and to cool the secondary fluid, and return the secondary fluid to the sub-system.

9. The fluid flow control system in combination with the internal combustion engine according to claim 6, further comprising an electrical generator coupled with the moving fluid expander for being driven by the moving fluid expander so as to produce electrical current.

10. The fluid flow control system in combination with the internal combustion engine according to claim 9, further comprising an electrical energy storage device and a charging device connected therewith, the charging device being arranged to receive the electrical current produced by the electrical generator and to charge the electrical energy storage device.

11. A method for controlling flow of an expandable primary fluid to a flow-inducing device, comprising the steps of:
expanding the primary fluid in a moving fluid expander that extracts mechanical power from the primary fluid and causes a reduction in temperature of the primary fluid;
causing the reduced-temperature primary fluid to undergo heat exchange with a higher-temperature secondary fluid such that the secondary fluid is cooled by the primary fluid; and
supplying the primary fluid from the heat exchanger to a downstream flow-inducing device.

12. The method of claim 11, further comprising the step of regulating the heat exchange between the primary and secondary fluids so as to control the temperature of the primary fluid supplied to the flow-inducing device.

13. The method of claim 12, wherein the flow-inducing device comprises an internal combustion engine having an air intake manifold and the primary fluid includes air, and wherein the supplying step comprises supplying the primary fluid to the intake manifold.

14. The method of claim 12, further comprising the step of controlling how much the primary fluid is expanded in the moving fluid expander.

15. The method of claim 12, wherein the secondary fluid comprises air from a passenger compartment of a vehicle, and further comprising the step of supplying the secondary fluid cooled by the primary fluid back to the passenger compartment.

16. The method of claim 12, wherein the secondary fluid flows in an open fluid circuit.

17. The method of claim 12, wherein the secondary fluid flows in a closed fluid circuit.

18. The method of claim 12, further comprising the step of using the moving fluid expander to drive one or more auxiliary devices.

19. The method of claim 18, wherein the one or more auxiliary devices include an electrical generator that generates electrical current, and further comprising the step of charging an electrical storage device using the electrical current from the generator.

20. The method of claim 18, wherein the one or more auxiliary devices are directly driven by the expander through a mechanical connection therebetween.

21. The method of claim 18, wherein the one or more auxiliary devices are indirectly driven.
